(19) United States
(12) Patent Application Publication
(10) Pub. No.: US 2009/0153097 A1
(43) Pub. Date: Jun. 18, 2009

(54) Battery charging apparatus

(75) Inventors: Hong Seok Song, Gyeonggi-do (KR); Ji Hoon Jang, Gyeonggi-do (KR); Young Kook Lee, Seoul (KR); Jin Hwan Jung, Gyeonggi-do (KR)

Correspondence Address: Edwards Angell Palmer & Dodge LLP, P.O. Box 55874, Boston, MA, 02205, US

(73) Assignee: Hyundai Motor Company, Seoul (KR)

(21) Appl. No.: 12/152,158

(22) Filed: May 12, 2008

(30) Foreign Application Priority Data
Dec. 12, 2007 (KR) 10-2007-0129369

(51) Int. Cl. H02J 7/00

(52) U.S. Cl. 320/107

(57) ABSTRACT

The present invention provides a battery charging apparatus with reduced weight, volume and manufacturing cost. The apparatus includes: an alternating current power source including a first electrode and a second electrode and supplying an alternating voltage for charging the battery; a diode including an anode electrode connected to the battery and a cathode electrode connected to the second electrode and half-wave rectifying the alternating voltage applied from the alternating current power source; a three-phase motor connected to the first electrode and transmitting to the battery the half-wave rectified voltage applied from the diode and the alternating current power source; and an inverter connected between the three-phase motor and the battery and converting the voltage applied from the three-phase motor into a direct voltage to transmit the direct voltage to the battery. Alternatively, the apparatus may comprise an alternating current power source, an inverter, a three-phase motor and a switching unit.

### CROSS-REFERENCE TO RELATED APPLICATION

This application claims under 35 U.S.C. §119(a) the benefit of Korean Patent Application No. 10-2007-0129369 filed Dec. 12, 2007, the entire contents of which are incorporated herein by reference.

### BACKGROUND

(a) Technical Field

The present invention relates to a battery charging apparatus. More particularly, the present invention relates to a battery charging apparatus with reduced weight, volume and manufacturing cost.

(b) Background Art

A battery charging apparatus for a vehicle stores power supplied from an external power source in a high-voltage battery, and the vehicle is driven using the power stored in the battery.

In this case, since the voltage applied from the external power source is an alternating voltage, the battery charging apparatus requires a separate charger for converting the alternating voltage into a direct voltage and supplying the same to the battery.

Also, since the charging current and voltage applied from the external power source to the battery through the charger is necessary to be high for a rapid charge of the battery, which requires high-capacity devices in the battery, increasing the volume and cost of the battery charging apparatus.

The charger may be composed of a plurality of insulated gate bipolar transistors (IGBTs), capacitors, and a controller, and the volume and weight of the plurality of IGBTs and capacitors are necessary to be increased, resulting in increasing the manufacturing cost of the battery charging apparatus employing such high-capacity devices.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art. One of the objects of the present invention is to provide a battery charging apparatus with reduced weight, volume and manufacturing cost.

In a preferred embodiment, the present invention provides a battery charging apparatus comprising: an alternating current power source including a first electrode and a second electrode and supplying an alternating voltage for charging a battery; a diode, of which an anode electrode is connected to the battery and a cathode electrode is connected to the second electrode of the alternating current power source, for half-wave rectifying the alternating voltage applied from the alternating current power source; a three-phase motor connected to the first electrode of the alternating current power source and transmitting the half-wave rectified voltage applied from the diode and the alternating current power source to the battery; and an inverter connected between the three-phase motor and the battery and converting the voltage applied from the three-phase motor into a direct voltage to transmit the same to the battery.

In another preferred embodiment, the present invention provides a battery charging apparatus comprising: an alternating current power source supplying an alternating voltage for charging a battery; a three-phase motor connected to the alternating current power source and including a plurality of windings and a neutral point; an inverter connected between the three-phase motor and the battery and converting the alternating voltage applied from the alternating current power source into a direct voltage to transmit the same to the battery; and a switching unit including a first switch, a second switch, and a third switch, and connected to the neutral point of the three-phase motor and the respective windings of the three-phase motor.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

The above and other features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinafter by way of illustration only, and thus are not limitative of the present invention, and wherein:

FIG. 1 is a circuit diagram showing a battery charging apparatus in accordance with a preferred embodiment of the present invention; and

FIG. 2 is a circuit diagram showing a battery charging apparatus in accordance with another preferred embodiment of the present invention.

Reference numerals set forth in the Drawings includes reference to the following elements as further discussed below:
100, 200: battery charging apparatus
110, 210: alternating current power source
120, 220: three-phase motor
130, 230: inverter
140: diode
240: switching unit
B: battery

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to the preferred embodiments of the present invention, examples of which are illustrated in the drawings attached hereinafter, wherein like reference numerals refer to like elements throughout. The embodiments are described below so as to explain the present invention by referring to the figures.

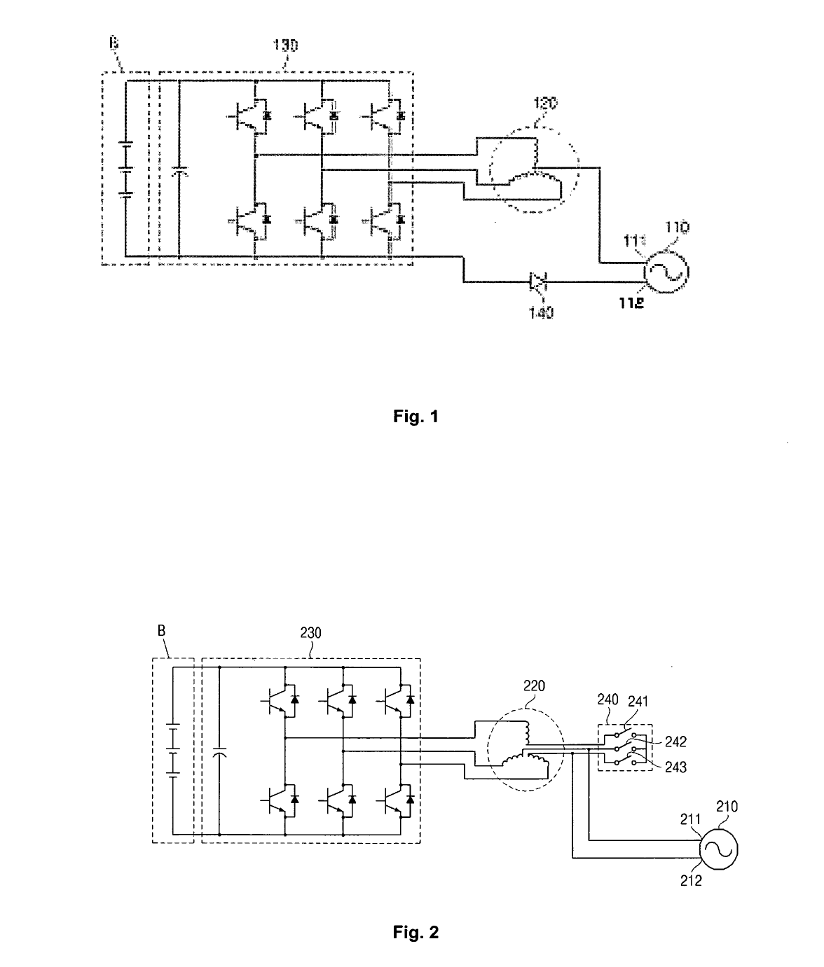

Referring to FIG. 1, a circuit diagram showing a battery charging apparatus in accordance with a preferred embodiment of the present invention is depicted.

As shown in the figure, the battery charging apparatus 100 includes an alternating current power source 110, a three-phase motor 120, an inverter 130, and a diode 140. The battery charging apparatus 100 may be used as an apparatus for charging a battery of a variety of vehicles including, for example, an electric vehicle, a plug-in fuel cell vehicle, or a plug-in hybrid vehicle.

First, the alternating current power source 110 includes a first electrode 111 and a second electrode 112. The first electrode 111 is connected to a neutral point of the three-phase motor 120, and the second electrode 112 is electrically connected to a cathode electrode of the diode 140. An alternating voltage applied from the alternating current power source 110 is converted into a half-wave alternating voltage by the diode 140.

While the battery is charged, the first electrode 111 and the second electrode 112 of the alternating current power source 110 are connected to the three-phase motor 120 and the diode 140, respectively. During operation of the vehicle, the first electrode 111 and the second electrode 112 are opened. Since the three-phase motor 120 is driven by a voltage applied from the battery B during operation of the vehicle, the circuit between the alternating current power source 110 and the three-phase motor 120 is opened, and thus it is possible to prevent the circuit between the alternating current power source 110 and the three-phase motor 120 and the circuit between the alternating current power source 100 and the diode 140 from being shorted. In this case, the circuit between the alternating current power source 110 and the three-phase motor 120 and the circuit between the alternating current power source 110 and the diode 140 may be connected or opened by various non-limiting means such as a switch, an outlet or an equivalent circuit thereof.

The three-phase motor 120 includes three windings connected by a three-phase connection. The three windings of the three-phase motor 120 are connected by a Y connection such that the neutral point is connected to the first electrode 111 of the alternating current power source 110 and the respective windings are connected to the inverter 130. The three-phase motor 120 half-wave rectifies the alternating voltage applied from the alternating current power source 110 and transmits the same to the inverter 130.

The inverter 130 is connected between the battery B and the three-phase motor 120. The inverter 130 converts the alternating voltage half-wave rectified by the diode 140 into a direct voltage and supplies the same to the battery B. At this time, the battery B is charged with the direct voltage transmitted from the inverter 130. During operation of the vehicle, the inverter 130 converts the direct voltage supplied from the battery B into an alternating voltage and supplies the same to the three-phase motor 120. At this time, the three-phase motor 120 is driven by the alternating voltage applied from the inverter 130.

The diode 140 includes an anode electrode and a cathode electrode. The anode electrode is connected to the battery B and the cathode electrode is connected to the second electrode 112 of the alternating current power source 110. The battery B includes two electrodes, in which the electrode connected to the anode electrode of the diode 140 has a lower electric potential. Since the anode electrode of the diode 140 is connected to the electrode of the battery B having a lower electric potential, it is possible to prevent the respective circuits from being shorted during charging of the battery.

The above-described battery charging apparatus 100 can charge the battery B by adding the diode 140 to the inverter 130 and the three-phase motor 120 without using a separate charger. Accordingly, the number of parts employed in the battery charging apparatus 100 is reduced, thereby reducing the weight, volume and manufacturing cost of the battery charging apparatus 100.

Next, referring to FIG. 2 a circuit diagram showing a battery charging apparatus in accordance with another preferred embodiment of the present invention is depicted. Likewise, the battery charging apparatus 200 may be used for charging a battery of a variety of vehicles including, for example, an electric vehicle, a plug-in fuel cell vehicle, or a plug-in hybrid vehicle.

As shown in the figure, the battery charging apparatus 200 includes an alternating current power source 210, a three-phase motor 220, an inverter 230, and a switching unit 240. The switching unit 240 includes a first switch 241, a second switch 242, and a third switch 243.

First, the alternating current power source 210 includes a first electrode 211 and a second electrode 212. The first electrode 211 is connected to the three-phase motor 220 and the second switch 242, and the second electrode 212 is electrically connected to the three-phase motor 220 and the third switch 243. While the battery is charged, the first electrode 211 and the second electrode 212 of the alternating current power source 210 are connected between the three-phase motor 220 and the switching unit 240, respectively. During operation of the vehicle, the first electrode 211 and the second electrode 212, connected between the three-phase motor 220 and the switching unit 240, are opened. Since the three-phase motor 220 is driven by a voltage applied from the battery B during operation of the vehicle, the circuit between the alternating current power source 210 and the three-phase motor 220 is opened, and thus it is possible to prevent the circuit between the alternating current power source 210 and the three-phase motor 220 from being shorted. In this case, the circuit between the alternating current power source 210 and the three-phase motor 220 may be connected or opened by various means including, for example, a switch, an outlet or an equivalent circuit thereof; the circuit used in the present invention is not particularly limited.

The three-phase motor 220 is connected between the inverter 230 and the alternating current power source 210. The three-phase motor 220 includes three windings connected by a three-phase connection. The three windings of the three-phase motor 220 are connected to the first switch 241, the second switch 242, and the third switch 243 of the switching unit 240, respectively. The winding connected to the second switch 242 is coupled to the first electrode 211 of the alternating current power source 210, and the winding connected to the third switch 243 is coupled to the second electrode 212 of the alternating current power source 210. The three-phase motor 220 is supplied with an alternating voltage from the alternating current power source 210 and converts the same into a direct voltage by means of the windings of the three-phase motor 220 and the inverter 230. In this case, the windings of the three-phase motor 220 are operated by an inductor.

The inverter 230 is connected between the battery B and the three-phase motor 220. The inverter 230 converts the voltage applied from the three-phase motor 220 into a direct voltage and supplies the same to the battery B. The battery B is charged with the direct voltage transmitted from the inverter 230. During operation of the vehicle, the inverter 230 converts the direct voltage supplied from the battery B into an alternating voltage and supplies the same to the three-phase motor 220. The three-phase motor 220 is driven by the alternating voltage applied from the inverter 230.

The switching unit 240 includes the first switch 241, the second switch 242, and the third switch 243 and is connected to the respective windings and a neutral point of the three-phase motor 220. The second switch 242 is connected to the first electrode 211 of the alternating current power source 210, and the third switch 243 is connected to the second electrode 212 of the alternating current power source 210. While the battery B is charged, the switching unit 240 is turned off to open the circuits between the respective windings and the neutral point of the three-phase motor 220, thus transmitting the voltage applied from the alternating current power source 210 to the inverter 230 using the windings of the three-phase motor 220 as the inductor. While the vehicle is operated, the switching unit 240 is turned on to connect the respective windings of the three-phase motor 220 to the neutral point of the three-phase motor 220. At this time, the inverter 230 converts the direct voltage applied from the battery B into an alternating voltage and transmits the same to the three-phase motor 220 to be driven.

The above-described battery charging apparatus 200 can charge the battery B by adding the switching unit 240 to the inverter 230 and the three-phase motor 220 without using a separate charger. Accordingly, since the number of parts employed in the battery charging apparatus 200 is reduced, thereby reducing the weight, volume and manufacturing cost of the battery charging apparatus 200.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An apparatus for charging a battery comprising:
an alternating current power source including a first electrode and a second electrode and supplying an alternating voltage for charging the battery;
a diode including an anode electrode connected to the battery and a cathode electrode connected to the second electrode and half-wave rectifying the alternating voltage applied from the alternating current power source;
a three-phase motor connected to the first electrode and transmitting to the battery the half-wave rectified voltage applied from the diode and the alternating current power source; and
an inverter connected between the three-phase motor and the battery and converting the voltage applied from the three-phase motor into a direct voltage to transmit the direct voltage to the battery.

2. An apparatus for charging a battery comprising:
an alternating current power source supplying an alternating voltage for charging the battery;
a three-phase motor connected to the alternating current power source and including windings and a neutral point;
an inverter connected between the three-phase motor and the battery and converting the alternating voltage applied from the alternating current power source into a direct voltage to transmit the direct voltage to the battery; and
a switching unit including a first switch, a second switch, and a third switch and connected to the neutral point of the three-phase motor and the respective windings of the three-phase motor.

3. The battery charging apparatus of claim 2, wherein the alternating voltage applied from the alternating current power source is converted into a direct voltage by the windings of the three-phase motor and the inverter and then applied to the battery.

4. The battery charging apparatus of claim 2, wherein the alternating current power source comprises a first electrode connected between the three-phase motor and the second switch, and a second electrode connected between the three-phase motor and the third switch.

5. The battery charging apparatus of claim 4, wherein the first switch, the second switch, and the third switch of the switching unit, while the battery is charged, are turned off such that the alternating voltage of the alternating current power source is applied to the battery through the windings of the three-phase motor to charge the battery.

6. The battery charging apparatus of claim 2, wherein the first switch, the second switch, and the third switch of the switching unit, while the three-phase motor is driven by the battery, are turned on such that the respective windings of the three-phase motor are connected to the neutral point of the three-phase motor.
